(19) United States
(12) Patent Application Publication
(10) Pub. No.: US 2013/0156416 A1
(43) Pub. Date: Jun. 20, 2013

(54) PACKET-OPTICAL COMBINED SWITCHING SYSTEM AND PROTECTION SWITCHING METHOD THEREOF

(71) Applicant: Electronics and Telecommunications Research In, Daejeon (KR)

(72) Inventors: Ki Won KIM, Daejeon (KR); Ho Young SONG, Daejeon (KR); You Hyeon JEONG, Daejeon (KR)

(73) Assignee: Electronics and Telecommunications Research Institute, Daejeon (KR)

(21) Appl. No.: 13/658,361

(22) Filed: Oct. 23, 2012

(30) Foreign Application Priority Data
Dec. 19, 2011 (KR) 10-2011-0137366

(51) Int. Cl. H04B 10/08

(52) U.S. Cl. 398/2

(57) ABSTRACT

A protection switching method of packet-optical combined switching system in accordance with the inventive concept may include detecting whether or not an obstacle occurs in a packet path; performing a first protection switching using a preliminary path if an obstacle is detected from the packet path; generating an imaginary preliminary path using a preliminary resource of optical path when the first protection switching is failed; and performing a second protection switching using the imaginary preliminary path.

### CROSS-REFERENCE TO RELATED APPLICATIONS

This U.S. non-provisional patent application claims priority under 35 U.S.C. §119 of Korean Patent Application No. 10-2011-0137366, filed on Dec. 19, 2011, the entire contents of which are hereby incorporated by reference.

### BACKGROUND

The present inventive concept herein relates to protection restoration technology for optical path and packet path in packet-optical combined switching system, and more particularly, to provision of protection restoration service for packet path which is a high rank by generating a protection switching preliminary path of imaginary packet path by using a protection restoration path of optical path which is a low rank or an optical path resource.

A conventional network is a complicated overlay in which a packet network, a line network and an optical transport network are mixed and hierarchy equipments are sporadically installed, operated and managed. However, as a packet-optical combined network has been developed, these equipments are combined to be operated and managed.

The packet-optical combined switching system has a physical interface such as an optical transport network (OTN), an optical path, a packet path, and a synchronous optical NET work/synchronous digital hierarchy (SONET/SDH), an Ethernet, etc. In this case, a conventional protection switching method has an operation characteristic having no relation between an optical path and a packet path because they are independently performed.

When an obstacle occurs in the packet path which is a high rank, if there is a preliminary path or preliminary resource of protection switching for the packet path, a protection switching operation for the packet path is normally performed. However, when an obstacle occurs in the packet path which is a high rank, if there is no a preliminary path or preliminary resource of the packet path, a protection switching operation cannot be performed and thereby reliability of transmission service in a transport network device or a transport network cannot be provided.

### SUMMARY

Embodiments of the inventive concept provide a protection switching method of packet-optical combined switching system. The protection switching method may include detecting whether or not an obstacle occurs in a packet path; performing a first protection switching using a preliminary path if an obstacle is detected from the packet path; generating an imaginary preliminary path using a preliminary resource of optical path when the first protection switching is failed; and performing a second protection switching using the imaginary preliminary path.

Embodiments of the inventive concept also provide a packet-optical combined switching system. The packet-optical combined switching system may include a plurality of packet-optical combined switches; and a protection restoration control device controlling a protection switching for packet path or optical path of each of the plurality of packet-optical combined switches. The protection restoration control device generates an imaginary preliminary path using a preliminary resource of the optical path when an obstacle occurs in the packet path and performs a protection switching for the packet path using the generated the preliminary path.

### BRIEF DESCRIPTION OF THE FIGURES

Preferred embodiments of the inventive concept will be described below in more detail with reference to the accompanying drawings. The embodiments of the inventive concept may, however, be embodied in different forms and should not be constructed as limited to the embodiments set forth herein. Rather, these embodiments are provided so that this disclosure will be thorough and complete, and will fully convey the scope of the inventive concept to those skilled in the art. Like numbers refer to like elements throughout.

FIG. 1 is a drawing illustrating a packet-optical combined switching system for protection switching control in accordance with some embodiments of the inventive concept.

FIG. 2 is a drawing illustrating a general protection switching operation in a transport network constituted by the packet-optical combined switches in FIG. 1.

FIG. 3 is a drawing illustrating a protection restoration operation for a packet hierarchy working path by substituting a preliminary path of optical hierarchy with a preliminary path of imaginary packet hierarchy when a protection restoration for the packet path cannot be performed.

FIG. 4 is a drawing illustrating an operation of restoring a packet hierarchy working path in which an obstacle occurs by dynamically setting a resource of optical path hierarchy on a preliminary path of imaginary packet hierarchy.

FIG. 5 is a flow chart illustrating a protection restoration method in a transport network constituted by packet-optical combined switches.

### DETAILED DESCRIPTION OF THE EMBODIMENTS

Embodiments of inventive concepts will be described more fully hereinafter with reference to the accompanying drawings, in which embodiments of the invention are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

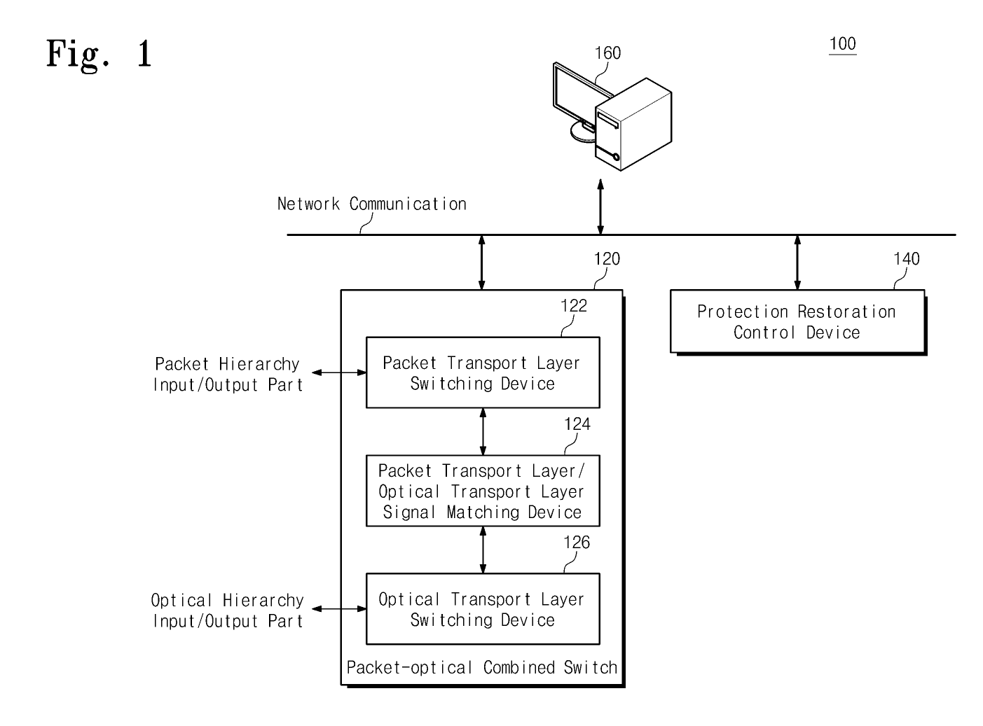

FIG. 1 is a drawing illustrating a packet-optical combined switching system 100 for protection switching control in accordance with some embodiments of the inventive concept. For convenience of description, it is described to be assumed that a wavelength division multiplexing (WDM) signal path is an L0 path, a synchronous optical NET work/synchronous digital hierarchy (SONET/SDH) signal path is an L1, an optical transport layer (OTL) path includes the L0 path and the L1 path, and a packet transport layer (PTL) path is an L2 path.

Referring to FIG. 1, the packet-optical combined switching system 100 includes a packet-optical combined switch 120, a protection restoration control device 140 and an operation system 160. The packet-optical combined switch 120, the protection restoration control device 140 and the operation system 160 are electrically connected to one another through a network communication line.

The packet-optical combined switch 120 includes a packet transport layer (PTL) switching device 122, a packet transport layer (PTL)/optical transport layer (OTL) signal matching device 124 and an optical transport layer (OTL) switching device 126.

The packet transport layer (PTL) switching device 122 performs a packet path transmission service or packet transport layer (PTL) switching of signal (or a packet signal) such as PPB-TE or MPLS-TP which is connected to a packet hierarchy input/output part. The packet transport layer (PTL) switching device 122 periodically analyzes a signal of operation path and a signal of preliminary path that are received through a packet hierarchy path to detect and notify whether an obstacle occurs or not and performs a protection switching of packet control path by a control of protection restoration control device.

The packet transport layer (PTL)/optical transport layer (OTL) signal matching device 124 performs a signal matching mapping an optical hierarchy path signal to a PTL packet hierarchy path or inversely mapping a packet hierarchy path signal to an optical hierarchy path signal.

The optical transport layer (OTL) switch device 126 performs WDM connected to an optical hierarchy input/output part, an optical path transmission service of SONET/SDH or an optical transport layer switching. The optical transport layer (OTL) switch device 126 periodically analyzes a signal of operation path and a signal of preliminary path that are received through an optical hierarchy path to detects and notify whether an obstacle occurs or not and performs a protection switching of optical control path by a control of protection restoration control device.

The protection restoration control device 140 is a device performing a protection restoration operation. The protection restoration control device 140 monitors a signal of each path of the packet transport layer (PTL) signal switching device 122 and the optical transport layer (OTL) switching device 126. If an obstacle occurs, the protection restoration control device 140 performs a protection restoration operation by controlling the packet transport layer (PTL) signal switching device 122 and the optical transport layer (OTL) switching device 126 in line with the packet hierarchy path and the optical hierarchy path.

In FIG. 1, the packet-optical combined switch 120 is illustrated to be one. However, the packet-optical combined switching system 100 is not limited thereto. The packet-optical combined switching system 100 may includes a plurality of packet-optical combined switches.

The packet-optical combined switching system 100 generates a preliminary resource of the optical path protection switching preliminary path and a protection switching preliminary path of imaginary packet path. The packet-optical combined switching system 100 can secure survivability of transmission network by including the protection switching control device 140 so that a packet path protection switching is performed using the preliminary resource of the optical path protection switching preliminary path and the protection switching preliminary path of imaginary packet path.

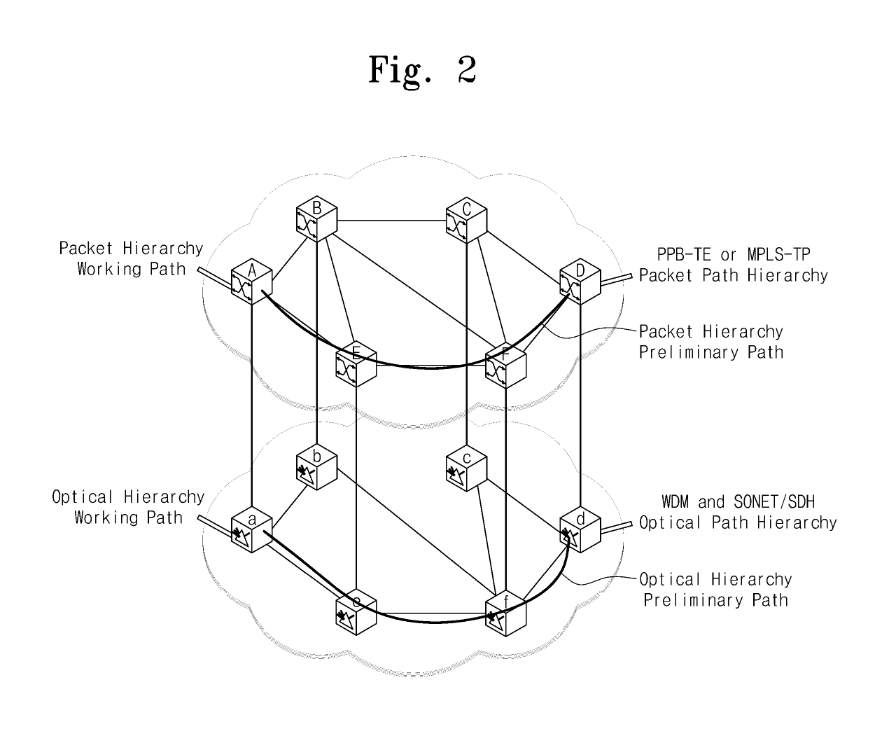

FIG. 2 is a drawing illustrating a general protection switching operation in a transport network constituted by the packet-optical combined switches 120 in FIG. 1. As illustrated in FIG. 2, the transport network constituted by the packet-optical combined switches 120 may be physically and logically classified into a packet path hierarchy network such as PPB-TE or MPLS-TP, and an optical path hierarchy network such as SONET/SDH and WDM.

In each hierarchy, in the packet path hierarchy, a node A-B-C-D which is a packet hierarchy working path and a node A-E-F-D which is a packet hierarchy preliminary path are set as a protection switching path and in the optical path hierarchy, a node a-b-c-d which is an optical hierarchy working path and a node a-e-f-d which is an optical hierarchy preliminary path are set as a protection switching path. Those protection switching paths monitor an obstacle which occurs in a hierarchy path of each hierarchy to perform a protection switching operation.

When performing a protection restoration in the packet hierarchy working path, if there is a preliminary path or a preliminary resource, the protection restoration is performed in the packet hierarchy. If there is not a preliminary path or a preliminary resource is exhausted, a path service fail of packet hierarchy occurs. In this case, since there is a device that can match a path signal of packet hierarchy and a path signal of optical hierarchy by mapping those path signals in the packet-optical combined switch 120, a restoration can be performed using that device.

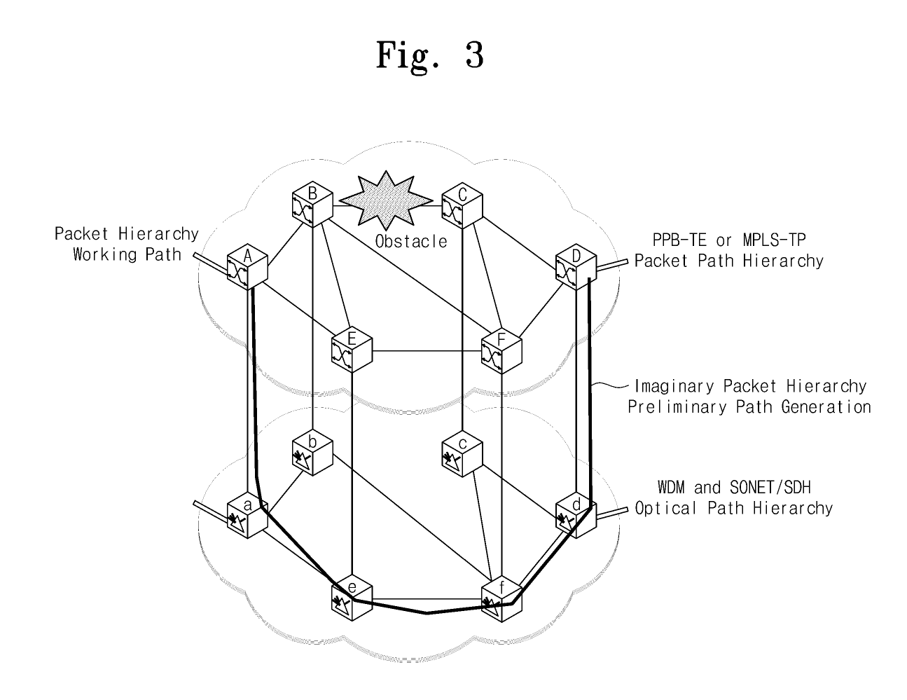

FIG. 3 is a drawing illustrating a protection restoration operation for a packet hierarchy working path by substituting a preliminary path of optical hierarchy with a preliminary path of imaginary packet hierarchy when a protection restoration for the packet path cannot be performed. In FIG. 3, when an obstacle occurs on a node A-B-C-D which is a packet hierarchy working path of packet path hierarchy, if a preliminary path is previously not set and a resource for preliminary path setting of the packet path is exhausted, an optical hierarchy preliminary path previously set in the protection restoration control device 140 is searched to distinguish whether the optical hierarchy preliminary path is an imaginary path that can be used as the packet hierarchy preliminary path. If the optical hierarchy preliminary path can be used as the packet hierarchy preliminary path, a protection restoration operation is performed using a node a-e-f-d which is an optical hierarchy preliminary path previously set in the optical path transport layer as an imaginary packet preliminary path as illustrated in FIG. 3. As a result, a protection restoration inability state due to a resource exhaustion of packet hierarchy.

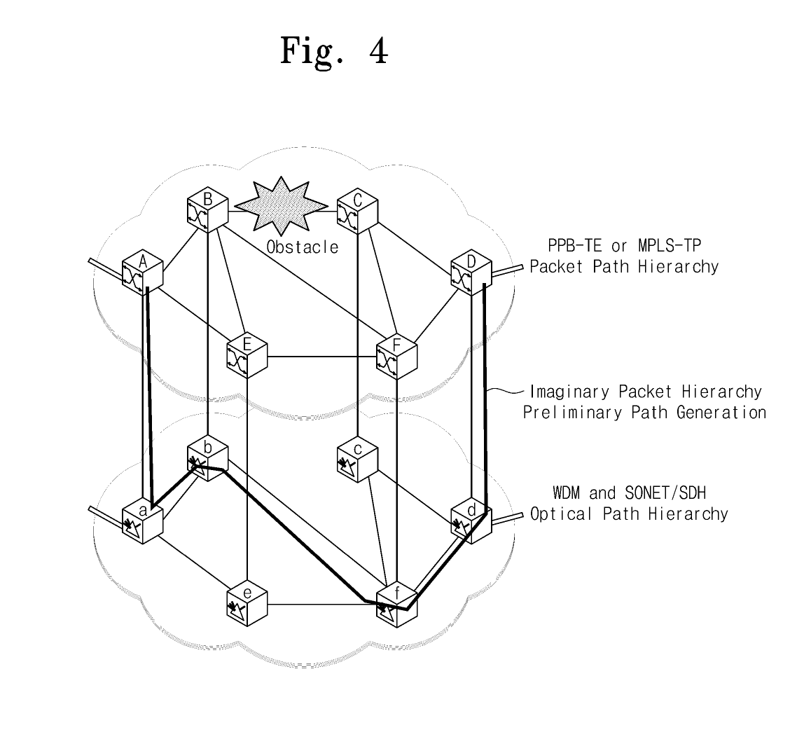

FIG. 4 is a drawing illustrating an operation of restoring a packet hierarchy working path in which an obstacle occurs by dynamically setting a resource of optical path hierarchy on a preliminary path of imaginary packet hierarchy. Referring to FIG. 4, in the case that since an obstacle occurs in a working path of packet path hierarchy, there are not a preliminary path of packet hierarchy and a preliminary path resource and there are not a preliminary path of imaginary optical path hierarchy that can be used as a packet hierarchy preliminary path, a resource of optical path hierarchy is researched by the protection restoration control device 140 to dynamically set a resource of possible optical path hierarchy to the preliminary path of packet hierarchy and thereby a protection restoration is performed on a working path of packet hierarchy in which an obstacle occurs.

When comparing FIG. 3 with FIG. 4, a protection restoration time of FIG. 3 using a preliminary path previously set is faster than an operation of FIG. 4. When a protection restoration service cannot be performed on all the packet path hierarchy, the packet-optical combined switch 120 can secure transmission service survivability of transmission network using a resource and a path of optical path hierarchy.

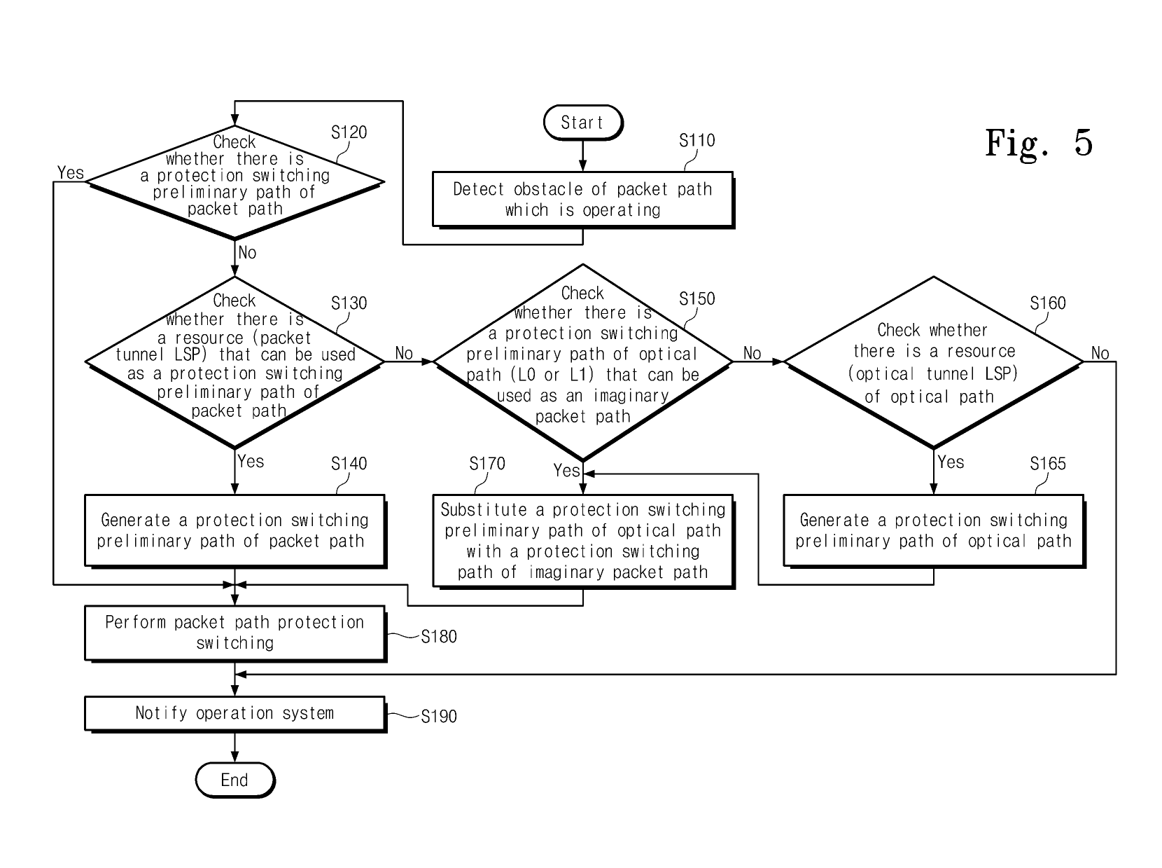

FIG. 5 is a flow chart illustrating a protection restoration method in a transport network constituted by packet-optical combined switches 120. Referring to FIGS. 1 and 5, a protection restoration method of transmission network is as follows.

The protection restoration control device 140 has jurisdiction over an operation control of protection restoration of packet hierarchy packet path and optical hierarchy optical path through the optical transport layer (OTL) switch device 126 such as WDM or SONET/SDH, the packet transport layer (PTL)/optical transport layer (OTL) signal matching device 124 and the packet transport layer (PTL) switching device 122.

An obstacle to a packet path (PTL path or L2 path) of high rank which is operating is detected. After that, it is checked whether there is a preliminary path of protection switching use for operation packet path previously set. If there is a preliminary path of protection switching use, a protection switching operation for packet path in which an obstacle just occurs is performed.

If there is not a preliminary path of protection switching use, a path resource (tunnel LSP) that can be used as a protection switching path in the packet path hierarchy is searched. If there is a resource that can be used as a protection switching path, the corresponding resource is generated to be a protection switching path of packet path. After that, a protection switching operation for packet path hierarchy in which an obstacle occurs is performed. A protection switching result of packet path is notified to the operation system 160.

If there is not a resource (imaginary packet path) that can be used as a protection switching path of packet path, it is checked whether there is a protection switching preliminary path of low rank optical path (SONET/SDH or WDM, L1 path or L0 path). If there is an optical path that can be used as an imaginary packet path, the protection switching path of optical path is generated to be a protection switching preliminary path of imaginary packet path. After that, a protection switching operation for an obstacle packet path is performed using the protection switching preliminary path of imaginary packet path generated as an optical path preliminary path.

If there is not a preliminary path of optical path that can be used as an imaginary packet path, a resource (optical path tunnel LSP) of optical path hierarchy that can be used as an imaginary packet path is searched. After that, if there is a resource of optical path, a protection switching preliminary path of optical path is generated and the generated protection switching preliminary path of optical path is substituted by a protection switching preliminary path of imaginary packet path.

Using the generated protection switching preliminary path of imaginary packet path, a protection switching operation is performed on a packet path in which an obstacle occurs. If there is not a resource of optical path that can be used as the imaginary packet path, a failure of protection switching operation on a packet path in which an obstacle occurs is notified to the operation system 160.

As described above, in the protection switching method in accordance with the inventive concept, if an obstacle is detected in a packet path of high rank and there is not a protection switching preliminary path for the corresponding packet path of high rank, a protection switching operation for the packet path of high rank is performed by searching a protection switching preliminary path of optical path hierarchy of low rank or an optical path resource to substitute the protection switching preliminary path or the optical path resource with a protection switching preliminary path of imaginary packet path. In a protection switching operation which is independently performed, when there is not a protection switching preliminary path of high rank path, a protection switching for the high rank path cannot be performed. However, in the inventive concept, when there is not a protection switching preliminary path of high rank path, a protection switching for the high rank path can be performed using a preliminary path of low rank path or a resource of low rank path.

In FIG. 5, for convenience of description, it was described to be assumed that a WDM signal path is an L0 path, a SONET/SDH signal path is an L1 path and a PTL packet path is an L2 path. However, L0/L1/L2 paths may be variously changed in actual application.

In the packet-optical combined switching system and the protection switching method thereof of the inventive concept, since there is a linkage relationship between the high rank path and the low rank path, when a protection restoration operation cannot be performed because there is not a protection switching preliminary path of packet path or a preliminary resource, an imaginary packet hierarchy preliminary path is generated using a protection switching preliminary path of optical path of low rank path or a preliminary resource to perform a protection restoration of packet path. Thus, survivability of transmission network can be secured.

The above-disclosed subject matter is to be considered illustrative, and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A protection switching method of packet-optical combined switching system comprising:
detecting whether or not an obstacle occurs in a packet path;
performing a first protection switching using a preliminary path if an obstacle is detected from the packet path;
generating an imaginary preliminary path using a preliminary resource of optical path when the first protection switching is failed; and
performing a second protection switching using the imaginary preliminary path.

2. The protection switching method of claim 1, wherein performing the first protection switching further comprises generating a new preliminary path using a resource of the packet path when there is not the preliminary path.

3. The protection switching method of claim 1, wherein generating the imaginary preliminary path further comprises mapping a path signal of packet hierarchy and a path signal of optical hierarchy.

4. The protection switching method of claim 3, wherein generating the imaginary preliminary path comprises:
searching a resource of optical hierarchy; and
generating the imaginary preliminary path using the searched resource.

5. The protection switching method of claim 4, further comprising notifying a failure of the second protection switching to an operation system if there is not a resource of optical hierarchy that can be used in a step of searching a resource of the optical hierarchy.

6. The protection switching method of claim 1, wherein the packet path is a high rank path and the optical path is a low rank path.

7. A packet-optical combined switching system comprising:
a plurality of packet-optical combined switches; and
a protection restoration control device controlling a protection switching for packet path or optical path of each of the plurality of packet-optical combined switches,
wherein the protection restoration control device generates an imaginary preliminary path using a preliminary resource of the optical path when an obstacle occurs in the packet path and performs a protection switching for the packet path using the generated the preliminary path.

8. The packet-optical combined switching system of claim 7, wherein each of the packet-optical combined switches comprises:
a packet transport layer switching device performing a packet path transmission service of packet signal connected to an input/output part of packet hierarchy or a switching of packet transport layer;
an optical transport layer switching device performing an optical path transmission service of optical signal connected to an input/output part of optical hierarchy; and
a signal matching device mapping the packet signal and the optical signal.

9. The packet-optical combined switching system of claim 8, wherein the optical transport layer switching device periodically analyzes the optical signal to detect whether an obstacle occurs in the optical path.

10. The packet-optical combined switching system of claim 8, wherein the packet transport layer switching device periodically analyzes the packet signal to detect whether an obstacle occurs in the packet path.

11. The packet-optical combined switching system of claim 10, wherein the protection restoration control device controls the packet transport layer switching device to perform a protection switching for the packet path using a preliminary path when an obstacle occurs in the packet path.

12. The packet-optical combined switching system of claim 11, wherein the protection restoration control device controls the packet transport layer switching device to generate a new preliminary path using a resource of the packet hierarchy when there is not the preliminary path and perform a protection switching for the packet path using the new preliminary path.

13. The packet-optical combined switching system of claim 12, wherein the protection restoration control device controls the signal matching device to mapping the packet signal to the optical signal or inversely mapping the optical signal to the packet signal when there is not the preliminary path and a preliminary path cannot be generated from the packet hierarchy,
wherein the protection restoration control device controls the optical transport layer switching device to generate the imaginary preliminary path using a resource of the optical path, and
wherein the protection restoration control device controls the packet transport layer switching device to perform a protection switching for the packet path using the imaginary preliminary path.
